(19) United States
(12) Patent Application Publication
(10) Pub. No.: US 2008/0008815 A1
(43) Pub. Date: Jan. 10, 2008

(54) Bland tasting soy protein isolate and processes for making same

(76) Inventor: Myong J. Cho, Chesterfield, MO (US)

Correspondence Address: SOLAE, LLC, P. O. BOX 88940, ST. LOUIS, MO, 63188, US

(21) Appl. No.: 11/471,785

(22) Filed: Jun. 21, 2006

(51) Int. Cl. A23L 1/20

(52) U.S. Cl. 426/634

(57) ABSTRACT

The present disclosure discloses novel bland tasting soy protein isolates and processes for producing the bland tasting soy protein isolates. The soy protein isolates described herein have very low levels of fat and volatile compounds that cause off-flavors in soy and are particularly suited for application in any number of food and drink products that incorporate soy proteins.

### BACKGROUND OF THE DISCLOSURE

The present disclosure generally relates to bland tasting soy protein isolates and processes for making the same that utilizes a soy protein concentrate prepared using aqueous ethanol extraction as a starting material. More particularly, the present disclosure relates to bland tasting soy protein isolates having excellent functional characteristics and containing very low levels of volatile compounds that can negatively affect flavor characteristics.

In response to the results of recent research showing the negative effects of certain foods on health and nutrition, consumers are becoming more health conscious and monitoring their food intake more carefully. In particular, since animal products are the main dietary source of cholesterol and may contain high levels of saturated fats, health professionals have recommended that consumers significantly reduce their intake of red meats. As a substitute, many consumers are choosing soy products.

It is well known that vegetable products, such as soy protein products, contain no cholesterol. For decades, nutritional studies have indicated that the inclusion of soy protein in the diet actually reduces serum cholesterol levels in people who are at risk. Further, the higher the cholesterol level, the more effective soy proteins are in lowering that level. A number of foods and drink products available today utilize soy protein isolates including, for example, dry blended beverages, ready to drink beverages that are of neutral or acidic pH, yogurt, dairy products, breads, food and protein bars, cereal products, soups, gravies, infant formula, emulsified meat products, whole muscle meat products, ground meat products other meat products such as beef, pork, poultry, and seafood, meat analogs, and the like.

Despite all of the above advantages that soy proteins provide, it is well known that by supplementing foods with increased levels of dietary fiber and soy protein, taste can be seriously compromised. More particularly, protein sources, such as soy protein, can produce objectionable off-flavors in the finished products. For example, many consumers complain that high protein foods, like those supplemented with soy protein, taste grassy, beany, and bitter. Soy off-flavors may be responsible for most of the complaints with respect to the taste of soy-based products.

It is believed that the development of soy off-flavors is initiated when phospholipids and triglycerides undergo hydrolysis to yield polyunsaturated free fatty acids, which then react with molecular oxygen to form fatty acid hydroperoxides and other oxygenated lipid species. Both the hydrolysis and the oxidation can occur in enzyme-catalyzed and in non-enzyme-catalyzed reactions. The hydroperoxides then decompose into smaller molecules such as aldehydes and ketones and it is these small molecules that are responsible for the odor and flavor of vegetable oil-based products. In particular, Boatwright (U.S. Pat. No. 6,426,112), Boatwright et al., J. Food Sci. vol 66, page 1306 (2001), Boatwright et al., J. Food Sci. vol 65, page 819 (2000), Y. Feng, et al. (Aroma Active Compounds in Food, ACS Symposium Series 794, ed. G. R. Takeaka et al., page 251 (2001)), and A. Kobayashi et al. (J. Agric. Food Chem., vol. 43, page 2449 (1995)) have identified some of the most flavor active of these molecules in soy isolate and soymilk, which contribute to soy protein's unique flavor. Specifically, these molecules may include methanethiol, dimethyl trisulfide, 2-pentyl pyridine, (E,E)2,4-nonadienal, (E,Z)2,6-nonadienal, (E,E)2,4-decadienal, (E,Z)2,4 decadienal, acetophenone, hexanal, 1-octen-3-one, beta-damascenone, (E)2-nonenal, (E)4,5-epoxy-(E)-2-decenal, vanillin, maltol, 1-octen-3-ol, 2-pentyl furan, 2-heptanone, octanal, (E)3-octen-2-one, 2-decanone, benzaldehyde, dimethyl disulfide, and 2,3-butanedione. Most of these flavor active volatiles are derived from oxidation of polyunsaturated lipids. The formation of these flavor active molecules and their hydroperoxide precursors begins as soon as the bean is crushed and continues through the soy isolate manufacturing process. Traditional processing methods have not been completely successful in reducing the level of off-flavors and off-flavor precursors to an acceptable level in finished soy isolate or in foods to which it is added.

The conventional process for manufacturing soy protein isolate begins with the production of a full fat soy flake from the bean, which is substantially defatted with hexane. This process typically removes more than 80% of the acid hydrolysable lipids in the soy flake, as measured by AOAC Method 922.06. The majority of the lipids remaining in the extracted flake are phospholipids. Soy protein is then extracted from the defatted soy flour with water and separated from the insoluble vegetable matter using centrifugation. The extracted protein is precipitated, washed, re-suspended in water and spray dried as described, for example, in Hettiarachchy, et al., Soybeans: Chemistry, Technology, and Utilization, pp. 379-411, Aspen Publishers (1997), which is incorporated herein by reference in its entirety.

These processes have been generally unsuccessful in producing a soy protein isolate with an acceptable flavor because the hexane is inefficient at removing all of the phospholipids and triglycerides that contain polyunsaturated fatty acids; low levels of these off-flavor precursors, and some of the enzymes which act on them, remain after the hexane extraction. These components continue to generate off-flavors during the removal of hexane from the extracted soy flake at elevated temperatures. Appreciable quantities of the flavor-active volatiles are also present and may continue through the subsequent protein isolation steps to result in a soy protein isolate with the familiar grassy, beany flavors.

In addition to the volatile compounds mentioned above, isoflavones occur naturally in soybeans. Isoflavone compounds include daidzin, 6″-O-malonyldaidzin, 6″-O-acetyldaidzin, daidzein, genistin, 6″-O-malonylgenistin, 6″-O-acetylgenistin, genistein, glycitin, 6″-O-malonylglycitin, and glycitein. The isoflavone compounds are associated with the inherent bitter flavor of soybeans, and isolates produced therefrom. Additionally, it has now been recognized that potassium, which is also present in soybeans and products derived therefrom, may also contribute to the bitter off-flavors of soy protein products and isolates.

As is evident from the foregoing, a need exists in the industry for soy protein isolates with high functionality that have improved flavor characteristics and a reduced amount of off-flavor-inducing volatile compounds, isoflavones, and potassium. It would also be beneficial for the isolates to have a low total fat content as measured by acid hydrolysis, since it has been found that the amount of flavor active volatiles increases as the total fat content increases. Additionally, a need exists for processing methods for making these isolates.

### SUMMARY OF THE DISCLOSURE

In one embodiment, the present disclosure provides a soy protein isolate having excellent functionality and presenting a bland taste. The soy protein isolate is suitable for use in a number of foods and drink products. In one embodiment, the soy protein isolate comprises a total fat content as measured by acid hydrolysis of less than about 3%, a total isoflavones content of less than about 200 ppm, a total potassium content of less than about 7500 ppm, and a nitrogen solubility index of at least about 60%. In another embodiment, the soy protein isolate has very low levels of numerous volatile compounds known to cause off-flavors in soy protein isolates and products derived therefrom. Specifically, the soy protein isolate has very low levels of 3-methyl butanal, pentanal, hexanal, 1-octen-3-ol, 2-pentyl furan, (E)3-octen-2-one, and (E)2-octenal.

The present disclosure also provides processes for producing soy protein isolates having excellent functionality and presenting a bland taste. The process includes utilizing a soy protein concentrate prepared by aqueous ethanol extraction as a starting material and includes an initial heating and holding process to re-solubilize the soy proteins present in the soy protein concentrate. In one embodiment, the process additionally includes an enzyme hydrolysis treatment to further modify and functionalize the resulting soy protein isolate.

As such, the present disclosure is directed to a process for producing a soy protein isolate comprising first hydrating with water a soy protein concentrate prepared by aqueous ethanol extraction to produce a dispersion and heating the dispersion to a temperature of at least about 125° C. and holding the dispersion at that temperature for a period of at least about 5 seconds to about 30 seconds to produce a slurry. The slurry is then separated to produce a supernatant, the pH of which is adjusted with an acid to form a precipitate. The precipitate is separated and washed with water and then hydrated to form a hydrated precipitate slurry. The pH of the hydrated precipitate slurry is adjusted to a pH of from about 7 to about 8 to form a neutralized slurry.

The present disclosure is further directed to a process for producing a soy protein isolate comprising first hydrating with water a soy protein concentrate prepared by aqueous ethanol extraction to produce a dispersion and heating the dispersion to a temperature of at least about 125° C. and holding the dispersion at that temperature for a period of at least about 5 seconds to about 30 seconds to produce a slurry. The slurry is then separated to produce a supernatant, the pH of which is adjusted with an acid to form a precipitate. The precipitate is separated and washed with water and then hydrated to form a hydrated precipitate slurry. The pH of the hydrated precipitate slurry is adjusted to a pH of from about 7 to about 8 to form a neutralized slurry and then the neutralized slurry is heated to a temperature of at least about 125° C. and held at that temperature for a period of from about 5 seconds to about 30 seconds. An active enzyme is introduced into the neutralized slurry. Optionally, if an enzyme having a low inactivation temperature is used, the neutralized slurry can be cooled to a temperature below the inactivation temperature of the enzyme being used. The enzyme-containing neutralized slurry is then heated to a temperature of at least about 125° C. and held at that temperature for a period of at least about 5 seconds to inactivate the enzyme and form an enzyme-treated soy protein isolate slurry.

The present invention is further directed to a process for producing a soy protein isolate comprising first hydrating with water a soy protein concentrate prepared by aqueous ethanol extraction to produce a dispersion and heating the dispersion to a temperature of at least about 125° C. and holding the dispersion at that temperature for a period of at least about 5 seconds to about 30 seconds to produce a slurry. The slurry is then separated to produce a supernatant, the pH of which is adjusted with an acid to form a precipitate. The precipitate is separated and washed with water and then hydrated to form a hydrated precipitate slurry. The pH of the hydrated precipitate slurry is adjusted to a pH of from about 7 to about 8 to form a neutralized slurry and then the neutralized slurry is heated to a temperature of at least about 125° C. and held at that temperature for a period of from about 5 seconds to about 30 seconds to form a soy protein isolate slurry.

The present disclosure is further directed to a soy protein isolate comprising a total fat content as measured by acid hydrolysis of less than about 3%, a total isoflavones content of less than about 200 ppm, a total potassium content of less than about 7500 ppm, and a nitrogen solubility index of at least about 60%.

The present disclosure is further directed to a soy protein isolate comprising a total fat content as measured by acid hydrolysis of less than about 3% and a total isoflavones content of less than about 50 ppm.

The present invention is further directed to a soy protein isolate comprising a total isoflavones content of less than about 200 ppm, a total potassium content of less than about 7500 ppm, and a nitrogen solubility index of at least about 70%.

The present invention is further directed to a soy protein isolate comprising a total fat content as measured by acid hydrolysis of less than about 2%.

The present invention is further directed to a soy protein isolate comprising a total isoflavones content of less than about 50 ppm.

The present invention is further directed to a soy protein isolate comprising less than about 10 ppb 3-methyl butanal.

The present invention is further directed to a soy protein isolate comprising less than about 200 ppb pentanal.

The present invention is further directed to a soy protein isolate comprising less than about 20 ppb (E)3-octen-2-one.

The present invention is further directed to a soy protein isolate comprising less than about 4.0 ppb (E)2-octenal.

The present invention is further directed to a soy protein isolate comprising less than about 800 ppb hexanal.

The present invention is further directed to a soy protein isolate comprising less than about 20 ppb 1-octen-3-ol.

The present invention is further directed to a soy protein isolate comprising less than 20 ppb 2-pentyl furan.

The present disclosure is further directed to a soy protein isolate comprising a total fat content as measured by acid hydrolysis of less than about 3%, a total isoflavones content of less than about 200 ppm, a total potassium content of less than about 7500 ppm, and a nitrogen solubility index of at least about 60%, wherein the soy protein isolate is prepared from a process comprising first hydrating with water a soy protein concentrate prepared by aqueous ethanol extraction to produce a dispersion and heating the dispersion to a temperature of at least about 125° C. and holding the dispersion at that temperature for a period of at least about 5 seconds to about 30 seconds to produce a slurry. The slurry is then separated to produce a supernatant, the pH of which is adjusted with an acid to form a precipitate. The precipitate is separated and washed with water and then hydrated to form a hydrated precipitate slurry. The pH of the hydrated precipitate slurry is adjusted to a pH of from about 7 to about 8 to form a neutralized slurry. An active enzyme is introduced into the neutralized slurry. Optionally, if an enzyme having a low inactivation temperature is used, the neutralized slurry can be cooled to a temperature below the inactivation temperature of the enzyme being used. The enzyme-containing neutralized slurry is then heated to a temperature of at least about 125° C. and held at that temperature for a period of at least about 5 seconds to form an enzyme treated soy protein isolate slurry that is subsequently dried.

The present disclosure is further directed to a soy protein isolate comprising a total fat content as measured by acid hydrolysis of less than about 3%, a total isoflavones content of less than about 200 ppm, a total potassium content of less than about 7500 ppm, and a nitrogen solubility index of at least about 60%, wherein the soy protein isolate is prepared from a process comprising first hydrating with water a soy protein concentrate prepared by aqueous ethanol extraction to produce a dispersion and heating the dispersion to a temperature of at least about 125° C. and holding the dispersion at that temperature for a period of at least about 5 seconds to about 30 seconds to produce a slurry. The slurry is then separated to produce a supernatant, the pH of which is adjusted with an acid to form a precipitate. The precipitate is separated and washed with water and then hydrated to form a hydrated precipitate slurry. The pH of the hydrated precipitate slurry is adjusted to a pH of from about 7 to about 8 to from a neutralized slurry and then the neutralized slurry is spray dried.

The present invention is further directed to a soy protein isolate comprising a total isoflavones content of less than about 200 ppm, a total potassium content of less than about 7500 ppm, and a nitrogen solubility index of at least about 70%, wherein the soy protein isolate is prepared from a process comprising first hydrating with water a soy protein concentrate prepared by aqueous ethanol extraction to produce a dispersion and heating the dispersion to a temperature of at least about 125° C. and holding the dispersion at that temperature for a period of at least about 5 seconds to about 30 seconds to produce a slurry. The slurry is then separated to produce a supernatant, the pH of which is adjusted with an acid to form a precipitate. The precipitate is separated and washed with water and then hydrated to form a hydrated precipitate slurry. The pH of the hydrated precipitate slurry is adjusted to a pH of from about 7 to about 8 to form a neutralized slurry and then the neutralized slurry is heated to a temperature of at least about 125° C. and held at that temperature for a period of from about 5 seconds to about 30 seconds. An active enzyme is introduced into the neutralized slurry. Optionally, if an enzyme having a low inactivation temperature is used, the neutralized slurry can be cooled to a temperature below the inactivation temperature of the enzyme being used. The enzyme-containing neutralized slurry is then heated to a temperature of at least about 125° C. and held at that temperature for a period of at least about 5 seconds to form an enzyme treated soy protein isolate slurry that is subsequently dried.

The present invention is further directed to a soy protein isolate comprising a total isoflavones content of less than about 200 ppm, a total potassium content of less than about 7500 ppm, and a nitrogen solubility index of at least about 70%, wherein the soy protein isolate is prepared from a process comprising first hydrating with water a soy protein concentrate prepared by aqueous ethanol extraction to produce a dispersion and heating the dispersion to a temperature of at least about 125° C. and holding the dispersion at that temperature for a period of at least about 5 seconds to about 30 seconds to produce a slurry. The slurry is then separated to produce a supernatant, the pH of which is adjusted with an acid to form a precipitate. The precipitate is separated and washed with water and then hydrated to form a hydrated precipitate slurry. The pH of the hydrated precipitate slurry is adjusted to a pH of from about 7 to about 8 to from a neutralized slurry and then the neutralized slurry is heated to a temperature of at least about 125° C. and held at that temperature for a period of from about 5 seconds to about 30 seconds to form a soy protein isolate slurry that is subsequently spray dried.

Other features and advantages of this disclosure will be in part apparent and in part pointed out hereinafter.

### BRIEF DESCRIPTION OF THE DRAWINGS

FIG. 1 is a representation of a suitable headspace apparatus for use in Gas-Chromatography-Mass Spectrometry analysis as described herein.

### DETAILED DESCRIPTION OF THE PREFERRED EMBODIMENTS

In the present disclosure, the terms “bland” as in bland tasting and “improved” as in improved flavor are used interchangeably and refer to a soy protein isolate that has a non-objectionable taste or flavor. It is understood that such terms are the result of a diminished content of flavor active molecules that cause the typical beany taste of soy products.

The present disclosure is generally directed to soy protein isolates having excellent functionality in various foods and drink products and presenting a bland taste and processes for producing such soy protein isolates. The soy protein isolates have a reduced amount of various volatile compounds known to cause off-flavors in soy protein isolates, as well as having reduced levels of potassium and isoflavones, which can also negatively affect the taste properties of soy proteins. The processes described herein utilize a soy protein concentrate prepared by aqueous ethanol extraction as the starting material.

The bland-tasting soy protein isolates described herein are particularly suitable for use with a number of food products that commonly include soy products therein. For example, the soy protein isolates described herein can be suitably used in dry blended beverages, ready to drink beverages that are of neutral or acidic pH, yogurt, dairy products, breads, food and protein bars, cereal products, soups, gravies, infant formula, emulsified meat products, whole muscle meat products, ground meat products, other meat products such as beef, pork, poultry, seafood, meat analogs, and the like. The soy protein isolates may be included in any one of the food products noted herein, as well as others known in the art, in their commercially established satisfactory amounts.

The bland-tasting soy protein isolates of the present disclosure may be derived from suitable starting materials as described herein that have been produced from any number of commercially available soybeans. For example, the soybeans used to produce the starting materials described herein may be commoditized soybeans, non-commoditized soybeans, genetically modified soybeans, non-genetically modified soybeans, and/or hybrid soybeans. For example, the soybeans used to make the starting materials described herein could be soybeans known as “high beta-conglycinin” soybeans, low linolenic soybeans or high oleic soybeans.

The processes of the present disclosure for producing bland-tasting highly functional soy protein isolates include a number of steps. In the first step of the process, a soy protein concentrate prepared by aqueous ethanol extraction is hydrated with water to produce a suitable dispersion. A suitable soy protein concentrate prepared by aqueous ethanol extraction for use as a starting material in the processes of the present disclosure can be obtained by processing a soy protein source, such as soy flakes, by an extraction process using aqueous alcohol. Extraction processes for forming soy protein concentrates are well known and disclosed, for example, in U.S. Pat. No. 6,187,367, issued to Cho, et al. (Feb. 13, 2001) and U.S. Pat. No. 6,132,795, issued to Holbrook, et al. (Oct. 17, 2000).

One extraction process suitable for preparing a dry soy protein concentrate for use in the processes described herein includes obtaining a defatted soy flake material using the method discussed herein above. The defatted soy flake material may then be put through a solvent extraction process. Typically, the solvent for the extraction process is an aqueous alcohol. The aqueous alcohol extraction removes materials soluble therein, including a substantial portion of the isoflavones and carbohydrates. This produces a protein concentrate material that contains from about 65% to about 85% protein by weight on a dry basis, but which is significantly reduced in isoflavones concentration.

Alcohol extraction to remove alcohol soluble components from the protein is particularly preferred in the solvent extraction process since alcohol extraction generally produces a better tasting soy protein material compared to aqueous acid extraction. This type of extraction is based on the ability of the aqueous solvent solutions to extract the soluble sugar/carbohydrate fraction of the defatted soy flake without solubilizing its proteins. A suitable alcohol solvent is an aqueous solution of lower aliphatic alcohols, such as, methanol, ethanol, and isopropyl alcohol.

The aqueous alcohol typically used in the processes of the present disclosure is a neutral pH solution, that is, a solution having a pH less than 8.5 and more than about 6.0. Suitably, the aqueous alcohol extraction is conducted at a pH of from about 6.5 to about 7.5.

Typically, the alcohol should be a food grade reagent, and preferably is an aqueous ethanol solution. An aqueous ethanol solution may contain from about 55% to about 95% ethanol by volume. The defatted soy flake material should be contacted with sufficient solution to form a soy protein concentrate containing between about 65% and about 85% protein, by dry weight. Additionally, the resulting soy protein concentrate has a pH of about 7.0. The weight ratio of aqueous ethanol solution to defatted soy flake material may be from about 2:1 to about 20:1, and preferably is from about 5:1 to about 10:1. Preferably, the defatted soy flake material is extracted with the aqueous ethanol solution to facilitate removal of materials soluble in the aqueous ethanol solution from the defatted soy flake material. The aqueous ethanol solution is recirculated through the extractor until the residual carbohydrate and isoflavone content in the defatted soy flakes is reduced to the desired level. The above described aqueous alcohol extraction removes alcohol soluble components of the defatted soy flakes. The soy protein concentrates obtained from the extraction process can then be desolventized into a dry soy protein concentrate.

In order to impart the desired level of soy protein into the dry soy protein isolate described herein, suitable dry soy protein concentrate starting materials comprise from about 65% (by weight dry basis) to about 85% (by weight dry basis) soy protein. More suitably, the dry non-functional soy protein concentrate comprises about 70% (by weight dry basis) soy protein.

Alternatively, a suitable commercially available soy protein concentrate prepared by aqueous ethanol extraction can be used as the starting material in the processes of the present disclosure. For example, one suitable soy protein concentrate prepared by aqueous ethanol extraction is available from The Solae Company (St. Louis, Mo.) under the trademark PROCON® 2000. Another suitable soy protein concentrate prepared by aqueous ethanol extraction is available from The Solae Company under the trademark Danpro™ H.

The soy protein concentrate prepared by aqueous ethanol extraction starting material is hydrated with water that is typically heated to facilitate the hydration to produce a dispersion. The water may be heated from about 25° C. to about 35° C., for example, to assist in the hydration. Additionally, combinations of mixing techniques known in the art may be utilized to further hydrate the concentrate. The soy protein concentrate prepared by aqueous ethanol extraction is typically introduced into the water at a weight ratio of water to soy protein concentrate of from about 5:1 to about 30:1 and suitably from about 10:1 to about 20:1. Without being bound to a particular theory, it is believed that the ratio of water to starting material affects the isoflavone content of the final product. Higher ratios of water to starting material yields lower isoflavone content of the final product. Further, increasing the ratio of water to starting material increases final product yield.

After the hydration of the soy protein concentrate prepared by aqueous ethanol extraction is complete and the dispersion formed, the dispersion is heated to a temperature of at least about 125° C. for a time period of from about 5 seconds to about 30 seconds, suitably for about 9 seconds, to form a slurry. A preferred temperature to heat the dispersion to and hold it for the appropriate time is from about 145° C. to about 155° C., and suitably about 150° C. The dispersion may be heated by any means known in the art including, for example, by using a steam treatment, such as a direct steam treatment. The dispersion is heated and held at the elevated temperature in this step to solubilize the soy proteins present in the starting material soy protein concentrate because the soy proteins present in the starting material soy protein concentrate are primarily insoluble in water due to denaturation of the soy protein caused by the aqueous ethanol extraction used to produce the starting material. It has been found that heat treatment of the dispersion at this point in the soy protein isolate manufacturing process solubilizes the soy proteins in the starting material in water thus enabling separation of soy proteins and other soluble components from fiber in subsequent processing steps.

Once the slurry has been formed, it may optionally be flash cooled prior to additional processing. Flash cooling provides several potential benefits including (1) cooling the slurry so as to not heat denature the resolubilized proteins in the slurry; (2) removing water from the steam addition with vapor flashing; and (3) potentially removing off-flavor volatiles with vapor flashing. In a suitable embodiment, the flash cooling is performed by flashing under a vacuum. Alternatively, the slurry may be flash cooled at atmospheric pressure. Generally, the slurry is flash cooled to a temperature of from about 35° C. to about 85° C. using a vacuum pump, a condenser, and a tank rated for negative atmospheric conditions.

Optionally, the slurry, regardless of whether it has been flash cooled or not, may be pH adjusted prior to further processing as described below. In one embodiment, the slurry is pH adjusted to a pH of from about 8 to about 10, suitably from about 9 to about 10, more suitably from about 9.5 to about 9.7, and still more suitably about 9.7. The pH adjustment can be made with any suitable base such as, for example, sodium hydroxide. The pH adjustment may improve the overall yield of the process by allowing more protein to be extracted in the process.

After the heating and optional flash cooling and optional pH adjustment, the slurry is held for about 5 to about 20 minutes to allow for extraction of the proteins and separated to produce a supernatant (containing the soluble soy proteins) for further processing and a centrifuge cake (containing insoluble fiber) that is ultimately discarded. The separation may be done in a single step using a decanter centrifuge, for example, or may be done in two or more steps to improve overall soy protein yield. For example, in one embodiment, the separation comprises two separation steps, each of which utilizes a decanter centrifuge or similar centrifuge. In the first step, the slurry is centrifuged to produce a first supernatant and a first centrifuge cake. The first centrifuge cake is then diluted with water, typically at a temperature of about 30° C. to about 85° C., at a dilution weight ratio of, for example, 6:1 water to starting material, and centrifuged a second time to produce a second centrifuge cake and a second supernatant. The first and second supernatants, which contain the soy proteins, are combined for further processing and the second centrifuge cake is discarded.

Once the supernatant has been produced, it may optionally be further clarified to remove any remaining fine insoluble particles that may remain in the supernatant. In one embodiment, a disc centrifuge can be used for the clarification. Typically, the supernatant will be at a temperature of from about 35° C. to about 85° C. during the clarification. The clarification results in more purified soy protein isolates.

The pH of the supernatant is then adjusted to a pH of from about 4.2 to about 5.2, suitably about 4.5 to precipitate soy proteins and separate the insoluble protein from the undesirable components in subsequently described process steps. Any number of conventional acids such as hydrochloric acid, sulfuric acid, phosphoric acid, acetic acid, lactic acid and the like can be used for the separation. Both organic and inorganic acids are suitable for adjusting the pH of the supernatant. Generally, the pH of the supernatant is adjusted during the continuous mixing of the supernatant. Mixing may be performed by any standard equipment known in the art, such as, for example, mechanical agitators.

The formed precipitate is then separated from the undesirable components and washed with water to remove undesirable components from the precipitate. A weight ratio of water to starting material of about 2:1 can be used to wash the precipitate material while it is being separated in a disc centrifuge, for example. A single wash can be done, or multiple washes can be done to thoroughly wash the precipitate and remove undesirable components such as carbohydrates, minerals, and volatiles.

Once the precipitate is separated, it can optionally be hydrated with water to form a hydrated precipitate slurry. The water is typically added at a water to starting material weight ratio of about 5:1 to add enough fresh water into the system to further clean out any remaining undesirable components such as carbohydrates, minerals, and volatiles in the precipitate.

Prior to the hydrated precipitate slurry being separated it can optionally be heated to a temperature of from about 50° C. to about 85° C., suitably about 57° C. for a time period of from about 1 second to about 2 minutes, suitably from about 5 seconds to about 1 minute, and more suitably from about 5 seconds to about 30 seconds. This heating increases the solubility in the water of any remaining undesirable components and assists in their removal downstream.

Additionally, the hydrated precipitate slurry may optionally then be separated in a centrifuge, such as a decanter centrifuge to produce a concentrated cake, which is used for further processing, and a supernatant, which contains the undesirable components, that is discarded. The concentrated cake may then optionally be diluted with water to an appropriate percent solids, such as about 12% to about 15% for further processing. The precise amount of percent solids is not narrowly critical, so long as the amount of solids does not rise to the level where viscosity increases to a point where processing is affected.

The pH of the hydrated precipitate slurry is then adjusted to a pH of from about 6.5 to about 8, suitably from about 7 to about 8 to form a neutralized slurry. Specifically, in one embodiment, the pH of the hydrated precipitate slurry is adjusted to a pH of from about 7.2 to about 7.6 to form a neutralized slurry. In another embodiment, the pH of the hydrated precipitate slurry is adjusted to a pH of about 7.9 to form a neutralized slurry. The pH adjustment of the hydrated precipitate slurry re-solubilizes the precipitated soy protein in the hydrated precipitate slurry. Once the protein has been re-solubilized, the hydrated precipitate slurry can optionally be heated to a temperature of from about 125° C. to about 160° C., suitably from about 130° C. to about 150° C. and held at that temperature for a time period of from about 5 seconds to about 30 seconds, suitably from about 5 seconds to about 10 seconds. This optional heat treatment opens and unfolds the soy proteins present in the slurry, and makes more sites on the proteins available for modification in subsequent processing steps. Additionally, this heat treatment acts as a microbiological control step for soy proteins during the subsequent process such as an enzyme treatment at neutral pH range.

The neutralized slurry may then be optionally flash cooled as described above prior to further processing. In one embodiment of the present disclosure, the neutralized slurry is then hydrolyzed by the addition of an enzyme into the neutralized slurry to produce an enzyme-containing neutralized slurry. This enzyme treatment of the soy protein, or hydrolysis, modifies the soy protein and increases its functionality. Specifically, the enzymatic hydrolysis modifies the molecular weight of the soy proteins in such a way as to improve their functionality for use in beverage applications.

In one embodiment, the enzyme is introduced into the neutralized slurry at a level of from about 0.02% solids basis to about 3.0% solids basis, suitably from about 0.02% solids basis to about 1% solids basis. The enzyme may be allowed to react with the neutralized slurry at a pH of from about 7.0 to about 8.0, at a temperature of from about 50° C. (122° F.) to about 60° C. (140° F.), and for a time period of from about 15 minutes to about 120 minutes, suitably from about 30 minutes to about 60 minutes, prior to inactivation of the enzyme as discussed below.

Suitable enzymes for use in the processes of the present disclosure include protease enzymes such as, for example, Alcalase®, Protex®, Bromelain or any other enzyme having proteolytic activity. Suitable enzymes are known to those skilled in the art and are commercially available from numerous vendors such as, for example, Novozymes (Denmark), Valley Research (South Bend, Ind.), and Genencor (Palo Alto, Calif.). In a particularly preferred embodiment, the enzyme is Bromelain having an activity of 2500 TU/gram. Alternatively, the neutralized slurry can be directly treated as set forth below without the use of an enzyme hydrolysis step.

The enzyme-containing neutralized slurry (or the non enzyme-modified neutralized slurry) is optionally then heated to a temperature of from about 125° C. to about 160° C. for a period of at least about 5 seconds, suitably from about 5 seconds to about 30 seconds, and more suitably from about 9 seconds to about 30 seconds, to provide a microbiological kill and, if an enzyme was utilized, enzyme inactivation, and provide a pasteurized soy protein isolate slurry. The soy protein isolate slurry can then optionally be flash cooled as described above and dried by conventional methods, such as spray drying, to produce a hydrolyzed or unhydrolyzed dried powder soy protein isolate having at least 90% soy protein and excellent functionality.

The soy protein isolates derived from the processes described above are highly functional in foods and drink products and present a bland taste, which is highly desirable as noted herein. In one embodiment, the soy protein isolate has a low total isoflavones content to improve the taste of the soy protein isolate. A number of isoflavones are present in soy protein isolates such as, for example, daidzin, 6″-O-malonyldaidzin, 6″-O-acetyldaidzin, daidzein, genistin, 6″-O-malonylgenistin, 6″-O-acetylgenistin, genistein, glycitin, 6″-O-malonylglycitin, and glycitein. It is the sum of these named isoflavones that represent the total isoflavone content. The total amount of isoflavones present in the soy protein isolate can be easily determined by one skilled in the art. One suitable method for quantifying the isoflavones in the soy protein isolate is to extract the isoflavones from the soy protein isolate and compare the amount of isoflavones in the soy protein isolate with pure isoflavone standards. To extract the isoflavones, 0.75 grams of the soy protein isolate sample, which has been spray dried or finely ground, is mixed with 50 milliliters of 80/20 methanol/water solvent. The mixture is then shaken for 2 hours at room temperature with a conventional orbital shaker. After 2 hours, the remaining undissolved materials are removed by filtration through Whatman No. 42 filter paper. Five milliliters of the filtrate is diluted with 4 milliliters of water and 1 milliliter of methanol.

Once the isoflavones are extracted, the isoflavones are separated by High Performance Liquid Chromatography (HPLC) using a Hewlett Packard C18 Hypersil reverse phase column. The isoflavones are injected onto the column and eluted with a solvent gradient starting with 88% methanol, 10% water, and 2% glacial acetic acid and ending with 98% methanol and 2% glacial acetic acid. At a flow of 0.4 milliliters/minute, all the isoflavones, such as daidzin, 6″-O-malonyldaidzin, 6″-O-acetyidaidzin, daidzein, genistin, 6″-O-malonylgenistin, 6″-O-acetylgenistin, genistein, glycitin, 6″-O-malonylglycitin, and glycitein are clearly resolved. Peak detection is by UV absorbance at 260 mm. Identification of the peaks may be performed by a HP LC-mass spectrometer.

Quantification of the isoflavones is achieved by using pure standards, such as genistin, genistein, daidzin, and daidzein, available from Indofine Chemical Company (Sommerville, N.J.). Response factors (integrated area/concentration) are calculated for each of the above compounds and are used to quantitate the unknown samples. For the conjugated forms for which no pure standards are available, response factors are assumed to be that of the parent molecule but corrected for molecular weight difference. For example, the response factor for glycitin is assumed to be that for genistin corrected for molecular weight difference.

This method provides the quantities of each individual isoflavone. For convenience, total genistein, total daidzein, and total glycitein can be calculated, and represent the aggregate weight of these compounds if all the conjugated forms are converted to their respective unconjugated forms. Alternatively, the quantities of each individual isoflavone can be measured directly by a method using acid hydrolysis to convert the conjugated forms.

The soy protein isolates produced as described herein have a total isoflavones content of less than about 200 ppm, suitably less than about 100 ppm, more suitably less than about 75 ppm, and even more suitably less than about 50 ppm.

In addition to having a low isoflavones content, the soy protein isolates described herein may additionally have a low potassium content, which also improves the taste of the soy protein isolate by reducing bitterness. The total amount of potassium in a soy protein isolate can be measured using an Inductively Coupled Plasma (ICP) Mineral Screen according to the Official Methods of Analysis of the AOAC International, 16th Edition, Method 965.09, Locator 2.6.01 (Modified). In addition to potassium, this method also measures total amount of calcium, cobalt, copper, iron, magnesium, manganese, sodium, phosphorus, and zinc in a soy protein isolate.

The ICP method includes taking a 5.0 gram sample of the soy protein isolate, placing the sample into a weighed crucible and heating the sample in the weighed crucible on a hot plate set on high until the sample is charred and the smoking ceases. The crucible containing the charred sample is then placed in a pre-heated muffle furnace set at 500° C. and the sample is ashed to remove organic material by heating for a minimum of 6 hours, but typically heating for about 16 hours to form a white ash residue. 10 milliliters of 3N HCl is then added to the white ash residue in the crucible to form an acidic slurry, which is then heated on a hot plate for 15-20 minutes to solublize the minerals in the ash. The hot acidic slurry is then transferred to a 100-milliliter volumetric flask and allowed to cool to room temperature. After cooling, a sufficient amount of de-ionized water is added to the acidic slurry to fill the volumetric flask to 100 milliliters. The concentration of potassium as well as calcium, cobalt, copper, iron, magnesium, manganese, sodium, phosphorus, and zinc are determined by comparing the emission of the unknown sample to the emissions of standard solutions, measured by inductively coupled plasma atomic emission spectroscopy. The lowest confidence levels for this method are as follows: Potassium, 400 ppm; Calcium, 1000 ppm; Cobalt, 20 ppm; Copper, 4 ppm; Iron, 100 ppm; Magnesium, 200 ppm; Manganese, 20 ppm; Sodium, 400 ppm; Phosphorus 1000 ppm; Zinc, 100 ppm.

In one embodiment, the soy protein isolates have a potassium content of less than 7500 ppm, suitably less than 5000 ppm, more suitably less than 2500 ppm, and still more suitably less than 1000 ppm.

Additionally, the soy protein isolates described herein have high solubility in liquid systems which significantly improves the functionality of the isolate, especially in beverage applications. The solubility of a soy protein isolate can be measured by Nitrogen Solubility Index (NSI) for the isolate. NSI as used herein is defined as:

NSI=(% water soluble nitrogen of a protein containing sample/% total nitrogen in protein containing sample)×100.

The NSI provides a measure of the percent of water soluble protein relative to total protein in a protein containing material. The NSI of a soy protein material is measured in accordance with standard analytical methods, specifically A.O.C.S. Method Ba 11-65, which is incorporated herein by reference in its entirety. According to the Method Ba 11-65, a soy material sample (5 grams) ground fine enough so that at least 95% of the sample will pass through a U.S. grade 100 mesh screen (average particle size of less than about 150 microns) is suspended in distilled water (200 milliliters), with stirring at 120 revolutions per minute (rpm), at 30° C. for two hours; the sample is then diluted to 250 milliliters with additional distilled water. If the soy material is a full-fat material the sample need only be ground fine enough so that at least 80% of the material will pass through a U.S. grade 80 mesh screen (approximately 175 microns), and 90% will pass through a U.S. grade 60 mesh screen (approximately 205 microns). Dry ice should be added to the soy material sample during grinding to prevent denaturation of the sample. Sample extract (40 milliliters) is decanted and centrifuged for 10 minutes at 1500 rpm, and an aliquot of the supernatant is analyzed for Kjeldahl protein to determine the percent of water soluble nitrogen in the soy material sample according to A.O.C.S Official Methods Bc 4-91 (1997), Ba 4d-90, or Aa 5-91, each hereby incorporated by reference in their entirety. A separate portion of the soy material sample is analyzed for total protein to determine the total nitrogen in the sample. The resulting values of Percent Water Soluble Nitrogen and Percent Total Nitrogen are utilized in the formula above to calculate the Nitrogen Solubility Index.

The soy protein isolates described herein suitably have a Nitrogen Solubility Index of at least about 60%, more suitably at least about 70%, still more suitably at least about 75%, still more suitably at least about 80%, still more suitably at least about 85%, and still more suitably at least about 90%. At these levels, the soy protein isolates are highly soluble and have excellent functionality.

The soy protein isolates of the present disclosure additionally have a very low fat content, as measured by acid hydrolysis, which measures all of the fat content of the isolate. By being very low in fat content, the soy protein isolates are very low in polyunsaturated lipid content, which leads to a soy protein isolate with improved flavor. Typically lipids present in soy protein isolates, through oxidation and other mechanisms, result in the formation of volatile compounds as described herein that can lead to off-flavors in the resulting soy protein isolate. Thus, reducing lipid content improves flavor in the soy protein isolate.

The total amount of fat in a soy protein isolate (weight percent) can be measured using fat hydrolysis according to the Official Methods of Analysis of the AOAC International, 16th Edition, Method 922.06, Locator 32.1.13 (Modified). This method includes taking a 1.0-2.0-gram sample of the soy protein isolate and hydrolyzing the sample with dilute acidic alcohol to free heat-bound fats and oils contained in the sample. The fat is then extracted with a mixture of ethyl ether and petroleum ether, which is subsequently volatilized leaving the fat. The fat is dried, weighed, and quantitated as percent fat. A control sample is analyzed with each set of soy protein isolate samples. Specifically, the following procedure is used.

### Step 1

A 1.0-gram sample of the soy protein isolate is placed in a Mojonnier fat extraction flask (Type G-3, Mayer Co., Charleston, S.C.); 2.0 milliliters SDA (Specially Denatured Alcohol) and 10 milliliters dilute HCl (440 milliliters deionized Water mixed with 1 L 12 N HCl) are added to the soy protein isolate sample in the Mojonnier fat extraction flask.

### Step 2

The sample is agitated in a water bath at 70-80° C. for a total of 45 minutes or until hydrolysis is complete. Hydrolysis is deemed complete when the sample slurry is gray to black in color and no large chunks remain.

### Step 3

The hydrolyzed sample is removed from the water bath, and 5 milliliters of SDA are added to the hydrolyzed sample in the Mojonnier fat extraction flask. The hydrolyzed sample is swirled gently by hand and then allowed to cool to room temperature.

### Step 4

The fat is then extracted from the hydrolyzed sample by a mixture of ethyl ether and petroleum ether by the following process:
a. Add 25 milliliters ethyl ether to the Mojonnier fat extraction flask, tighten the stopper, shake vigorously by hand for 1 minute and remove the stopper.
b. Add 25 milliliters petroleum ether to the Mojonnier fat extraction flask, tighten the stopper, shake vigorously by hand for 1 minute and remove stopper to release pressure.
c. Centrifuge flask for 2 minutes at a speed sufficient to separate the solution into two distinct layers.
d. Prepare a stemless filter funnel with a cotton plug packed just firmly enough into the small funnel opening to allow ether to pass through freely and place the funnel on top of a tared 250-milliliter Griffin beaker.
e. Decant as much as possible of the sample's ether-fat solution (top layer in the Mojonnier fat extraction flask) through the prepared filter funnels.
f. Re-extract the hydrolyzed sample with 15 milliliter portions of ethyl ether and 15 milliliter portions of petroleum ether at least two more times repeating steps a-e, or until extracts are colorless.
g. Filter the top layer through the filter into the Griffin beaker that contains the original extract.
h. After the final extraction and filtration, rinse the funnel and cotton plug with three separate ethyl ether washes of about 10 milliliters each, collecting the rinses in the Griffin beaker containing the extracts.

### Step 5

The Griffin beaker containing the fat extracts is then placed on a steam bath at low setting under a hood to evaporate the ether; when all solvent has evaporated from the Griffin beaker, it is removed from the steam bath and the outside of the Griffin beaker is dried; the Griffin beaker is then placed in a forced-draft oven at 101° C. for 30-35 minutes; the Griffin beaker is then removed from the oven, placed in a dessicator to allow to cool about 30 minutes; the Griffin beaker is then removed from the dessicator and allowed to come to room temperature.

### Step 6

The Griffin beaker is then weighed and the gross weight recorded.

### Step 7

The % Fat is calculated using the following formula:

% Fat=(100)(G−T)/S

Where:
G=Gross weight of Griffin beaker, g
T=Tare weight of Griffin beaker, g
100=Conversion factor to %
S=Sample weight

Using a 2-gram sample, the lowest confidence level of this method is 0.1% fat.

The soy protein isolates as described herein have a total fat content (weight percent) as determined by acid hydrolysis of less than about 3.0% (by weight), suitably less than about 2.0% (by weight), more suitably less than about 1.90% (by weight), and still more suitably less than about 1.75% (by weight).

In addition to the above, the soy protein isolates produced in accordance with the present disclosure have very low levels of various volatile compounds. As previously noted, various volatile compounds can result in soy protein isolates having undesirable off-flavors. Specifically, the soy protein isolates have very low levels of at least one, or at least two, or at least three, or at least four, or at least five, or at least six, or even all seven of the following volatile compounds: (1) 3-methyl butanal; (2) pentanal; (3) hexanal; (4) 1-octen-3-ol; (5) 2-pentyl furan; (6) (E)3-octen-2-one; and (7) (E)2-octenal.

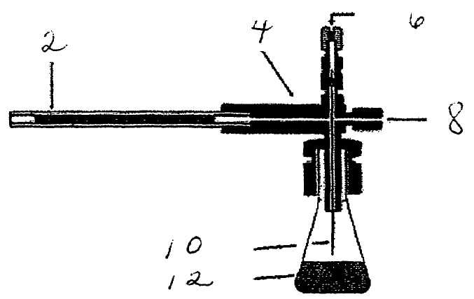

The amount of these volatiles in the soy protein isolates produced in accordance with the present disclosure can be measured using Dynamic Headspace (DHS) sampling with Gas-Chromatography-Mass Spectrometry (GC-MS) analysis. Specifically, GC-MS headspace analysis is an objective method for determining volatile constituents produced by a soy protein isolate by analyzing the vapor phase. A suitable headspace apparatus is shown in FIG. 1, and includes a desorption tube 2, a purge head 4, sparge gas inlet 6, dry purge gas inlet 8, sparge needle 10, and sample 12.

The temperature control of the sample 12 being analyzed in the headspace apparatus is maintained by the use of water jacketing. A 45° C. circulating water bath is connected via tygon tubing to a jacketed beaker large enough to hold the sample vessel, a 50-milliliter Erlenmeyer flask with a 24/40 ground glass joint (Kontes part 617000-0124). The jacketed beaker, containing water, sits on a digitally controlled stir plate with a built-in-timer (VWR Model 565 part 14217-602). A teflon purge head adapter (Scientific Instrument Services (SIS) part 164372) is fit to the Erlenmeyer flask, with a tube style purge head (SIS part 783009) fitted to the adapter. The purge head 4 also contains a sparging needle 10 adjusted such that the tip is 3 plus or minus 1 millimeter above the sample slurry meniscus and directs nitrogen extracting gas (99.999% pure) toward the surface of the sample 12. Nitrogen gas is obtained from the 60 psig house GC manifold system via a toggle valve and step-down regulator set at 20 psig. A tee coupling directs gas to two digital mass flow controllers (Aalborg part GFC171). The desorption tube 2 is attached to the purge head during sample collection.

To use GC-MS headspace analysis for an isolate, 5 grams plus or minus 0.005 grams of a soy protein isolate sample to be analyzed is weighed in a weigh boat. Ninety-five milliliters plus or minus 0.1 milliliters of reverse-osmosis water, available as Milli-Q from Millipore (Billerica, Mass.), is then measured into a graduated cylinder. The water is then transferred into a small (250 milliliters) Waring blender cup. To prepare a 5% soy protein slurry, the soy protein isolate sample is added into the blender. The sample and water are blended at a minimum blending speed for a period of about 1 minute to achieve a good dispersion. The 5% soy protein slurry is then transferred from the blender cup into an amber bottle. The amber bottle is sealed with a teflon lined screw cap and stored for a period of from about 14 hours to about 30 hours under refrigeration (35° F.-40° F.) to allow the volatiles to establish equilibrium between the soy protein, the aqueous phase, and the headspace. Prior to analysis, the sample bottle is warmed to room temperature by room equilibration or with warm water and stirring.

An internal standard solution is prepared from 4-heptanone (density 0.817 g/ml), available from Aldrich Chemical Co. (St. Louis, Mo.). To prepare the internal standard stock solution, 10.0 microliters of 4-heptanone is first added to reverse osmosis water in a 100-milliliter volumetric flask using a 10-microliter gas tight syringe. The flask is then made to volume with reverse osmosis water. Twelve milliliters of this solution is then added to a 100-milliliter flask which is made to volume with reverse osmosis water to obtain the internal standard stock solution. To a 20.0 gram sample of the 5% soy protein slurry is added 0.10 milliliters of the internal standard stock solution to obtain a concentration of 49 ppb 4-heptanone in the 5% slurry (equivalent to 980 micrograms 4-heptanone/kilogram soy protein isolate).

After the 5% soy protein slurry and internal standard solution are prepared, a sample extraction of the slurry is conducted. To extract the sample, a clean sample collection tube is attached (4 mm i.d. silco-treated stainless steel desorption tube, available as part 786002 from Scientific Instrument Services (SIS) (Ringoes, N.J., packed with 280 milligrams of 60/80 mesh Tenax-GR sorbent (SIS part 979401), held in place at each end with a small plug of silanized glass wool (Supelco part 2-0411))) to a headspace apparatus. Then, an octagonal stir bar (1×⅜″) is added to a 50-milliliter Erlenmeyer flask and 20.00 grams plus or minus 0.02 grams of sample slurry, which has been warmed to room temperature, is added into the flask. Additionally, 7.5 grams plus or minus 0.1 grams of analytical grade sodium chloride is added to the flask. So as not to create foam or wet flask sides or neck joint, the slurry is transferred with a pipette and the stir bar mixer is not activated at this time. 0.10 milliliters of the internal standard solution is then pipetted into the flask.

Immediately after adding the internal standard solution, a purge head 4 is placed firmly onto the Erlenmeyer flask to minimize any escape of the sample volatiles. The tip of the sparging needle 10 should be 3 plus or minus 1 millimeter above the sample slurry meniscus. The entire assembly is then placed into a water filled jacketed beaker, clamped in place, and attached to the two nitrogen line fittings. Without waiting for any temperature equilibration, the nitrogen line toggle valve is opened to start the extraction by firmly holding the purge head assemble in the Erlenmeyer flask neck joint (to prevent popping out by pressure surge). The stir plate is energized to produce 200 rpm. The top of the jacketed beaker is enclosed with aluminum foil to retain heat. The stirring slurry surface should contain little or no foam to facilitate maximum volatiles migration from liquid into headspace. Extraction is carried out for a period of 45 plus or minus 0.1 minutes using a 50 milliliters/minute nitrogen flow through the sparging needle 10. Simultaneously, diluting nitrogen gas (dry purge gas) passes through the top of the purge head 4 at a flow rate of 51 milliliters/minute to help flush water vapor through the desorption tube 2. After 45 minutes, the desorption tube 2 and cap are unscrewed and held at room temperature for GC-MS analysis.

To begin the GC-MS analysis, the desorption tube needle (SIS part #786035), containing a vespel seal (SIS part #786018), is attached to the sample inlet end of the desorption tube 2 that contains the purged volatiles. To the other end of the desorption tube, the autodesorb connecting tube (SIS part #786009) is attached. The assembly is placed into one of the twelve positions in the SIS Automated Short Path Thermal Desorption Injection System. Before beginning desorption, the desorption conditions are set as follows: purge: 1.00 minute, inject: 1.00 minute, desorb: 5.00 minutes at 280° C., heat delay: 0.5 minutes, start GC: 7.5 minutes, Cryo trap: −150° C., with the liquid nitrogen source attached, Cryo heat: 283° C., and desorb temp: 280° C. Additionally, the pressures of the gas manifold lines should be set as follows: helium: 60 plus or minus 1 psig and nitrogen: 60 plus or minus 1 psig, with a step-down to 20 psig during sample extraction. The GC-MS analysis is initiated with the ChemStation software that also initiates the SIS desorber system.

GC-MS analysis may be conducted using an Agilent® 6890N GC equipped with a 7973 MSD detector and Agilent® ChemStation software Version C.00.00 (Palo Alto, Calif.). Attached to the GC is a Scientific Instrument Services (SIS) AutoDesorb System with SIS controlling software Version 1.0.3. The conditions of the GC apparatus are set as follows: the injector contains SIS injection port liner SIPL 10 and its temperature is 280° C., with helium carrier gas at 1.1 milliliters/minute at split ratio 4.0:1; the column is an Agilent® Ultra 1-50 meters×0.32 millimeters, with 0.52 microns stationary phase (available as part 19091A-115 from Agilent); and the temperature is set initially at 35° C. and held for 1 minute, then raised 4° C./minute to 180° C., and then again raised 30.0° C./minute to 270° C. and held for 3 minutes. The conditions of the MS apparatus are set as follows: the transfer tube is 280° C.; source is 230° C.; vacuum is max 2×10-5 Torr; mass range is 27-350 a.m.u.; and scan frequency is at 3 Hz.

To analyze the data produced in the GC-MS analysis, the raw peak area obtained by extracted ion monitoring for the selected target ion in each target volatile was multiplied by a conversion factor. The conversion factors are obtained by dividing the combined abundance of the 10 most abundant ions in the spectrum of the authentic standard by the abundance of the target ion. The conversion factor for the internal standard peak area is determined with an authentic sample of 4-heptanone run on the mass spectrometer used for these analyses. The conversion factors for the target analytes are calculated from the spectra present in the NIST mass spectral library. The resulting peak area is representative of the total mass spectral response for that compound. This value was divided by the peak area for the internal standard and multiplied by 980, since the internal standard concentration is 980 ppb (when calculated on the basis of the starting isolate), to yield the concentration in ppb (microgram target volatile/kilogram soy protein isolate) for the target analyte.

The list of target compounds, with retention time (in minutes), target quantitation ion and conversion factor for use in converting the extracted ion peak area to total ion peak area are shown in Table 1.

TABLE 1

| | Retention | Target Quantitation | Conversion |
|---|---|---|---|
| Target Compound | Time (min.) | Ion | Factor |
| 3-methyl butanal | 6.2 | 58 | 10.84 |
| pentanal | 7.2 | 44 | 4.14 |
| hexanal | 10.5 | 56 | 5.70 |
| 1-octen-3-ol | 17.7 | 57 | 2.13 |
| 2-pentyl furan | 18.0 | 81 | 1.90 |
| (E) 3-octen-2-one | 19.7 | 111 | 6.30 |
| (E) 2-octenal | 20.4 | 70 | 9.20 |
| 4-heptanone (Internal | 13.5 | 114 | 14.72 |
| Standard) | | | |

In one embodiment of the present disclosure, the soy protein isolate comprises less than about 10 ppb 3-methyl butanal, suitably less than about 8.0 ppb 3-methyl butanal, suitably less than about 6.0 ppb 3-methyl butanal, and even more suitably less than about 4.0 ppb 3-methyl butanal.

In another embodiment of the present disclosure, the soy protein isolate comprises less than about 200 ppb pentanal, suitably less than about 150 ppb pentanal, suitably less than about 120 ppb pentanal and even more suitably less than about 80 ppb pentanal.

In another embodiment of the present disclosure, the soy protein isolate comprises less than about 800 ppb hexanal, suitably less than about 400 ppb hexanal, suitably less than about 350 ppb hexanal, and even more suitably less than about 300 ppb hexanal.

In yet another embodiment of the present disclosure, the soy protein isolate comprises less than about 30 ppb 1-octen-3-ol.

In yet another embodiment of the present disclosure, the soy protein isolate comprises less than about 20 ppb 2-pentyl furan, suitably less than about 15 ppb 2-pentyl furan, and even more suitably less than about 10 ppb 2-pentyl furan.

In yet another embodiment, the soy protein isolate comprises less than about 20 ppb (E)3-octen-2-one and suitably less than about 15 ppb (E)3-octen-2-one.

In still another embodiment, the soy protein isolate comprises less than about 4.0 ppb (E)2-octenal and even more suitably less than about 2.0 ppb (E)2-octenal.

The soy protein isolates described herein additionally have suitable viscosity properties to allow for their use in a number of food products. As used herein, the term “viscosity” means the apparent viscosity of aqueous slurry or a solution as measured with a rotating spindle viscometer utilizing a large annulus. In one embodiment, the viscosity of the soy protein isolate is measured using a Brookfield viscometer (available as Model LVT from Brookfield Engineering Laboratories, Inc., Middleboro, Me.). Specifically, to determine the viscosity, a sample of the soy protein isolate is dispersed in water at 23° C. to produce a 10% dispersion by weight. The spindle, #3, attached to the Brookfield viscometer, is rotated in the dispersion at a speed of either about 30 revolutions per minute (rpm) or about 60 rpm. Resistance of the dispersion on the spindle is measured by the viscometer in terms of centipoise.

The soy protein isolates (10% dispersion by weight in water) have a viscosity of less than about 400 centipoise, suitably less than about 300 centipoise, suitably less than about 200 centipoise, and more suitably less than about 100 centipoise.

### EXAMPLES

The following examples are simply intended to further illustrate and explain the present disclosure. The disclosure, therefore, should not be limited to any of the details in these examples.

### Example 1

In this Example, a soy protein isolate is prepared using a process of the present disclosure.

PROCON® 2000 (300 pounds) (The Solae Company, St. Louis, Mo.) is mixed with water and hydrated at a water to PROCON® 2000 weight ratio of about 10:1 to produce a dispersion. The water is at a temperature of about 32° C. to facilitate hydration. The dispersion is direct steam heated to about 154° C. and held at this temperature for about 9 seconds to produce a heated slurry. The heated slurry is then flash cooled to about 54° C. and is collected for further processing. The cooled slurry is centrifuged at a flow rate of about 110 pounds per minute in a co-current flow using two separation steps, each of which utilizes a decanter centrifuge (Sharples® P-3400 by Alfa-Laval, Sweden). The centrifuge cake from the first separation is diluted using water heated to about 32° C. at a 6:1 weight ratio of water to PROCON® 2000. The second centrifuge cake is discarded. The supernatant stream from the first and second centrifuge separations are combined and clarified at a rate of about 160 pounds per minute using a disc centrifuge. The solid material is discarded and the pH of the clarified supernatant is adjusted to about 4.5 using hydrochloric acid under continuous mixing to produce a precipitate.

The precipitate is washed with a 2:1 weight ratio of water to PROCON® 2000 while separating in a disc centrifuge. The liquor is discarded and the centrifuge cake is diluted with a 5:1 weight ratio of water to PROCON® 2000 and direct steam heated to about 57° C. for a time period of about 2 to 3 seconds and then separated with a decanter centrifuge. The supernatant is discarded and the concentrated cake is diluted to about 12.0% by weight solids with water.

The pH of the 12.0% solution is adjusted to about 7.9 with sodium hydroxide, and direct steam heated to about 129° C. and held at this temperature for about 9 seconds. After the holding period the solution is flash cooled to about 60° C. After the flash cooling, an enzyme (Bromelain) having an activity of about 2500 TU/g is added to the solution at about a 0.02% solids basis. The enzyme treated solution is allowed to react for about 30 minutes under continuous mixing at which point the enzyme reaction is terminated by direct steam heating the enzyme mixture to about 152° C. and holding the mixture at that temperature for about 9 seconds. The heated slurry is then flash cooled to about 54° C. and spray dried using an inlet temperature of about 237° C. and an outlet temperature of about 93° C.

### Example 2

In this Example, the soy protein isolate as prepared in Example 1 is analyzed to determine various properties of the soy protein isolate. The results of the analysis are shown in Table 2. All results are on a moisture-free basis (MFB) unless otherwise stated. Standard testing procedures are used for analysis unless otherwise disclosed herein.

TABLE 2

| | Amount Determined in |
|---|---|
| Composition or Element Determined | Soy Protein Isolate |
| Protein (weight percent) | 94.58 |
| Crude Fat (weight percent) | <0.1 |
| Fat by Acid Hydrolysis (weight percent) | 1.77 |
| Ash (weight percent) | 4.24 |
| Sodium (ppm) | 15,030 |
| Potassium (ppm) | 1178 |
| Calcium (ppm) | 1004 |
| Phosphorus (ppm) | 8,329 |
| Magnesium (ppm) | 553 |
| Isoflavones | 43.7 |
| (microgram/gram total dry matter) | |
| Daidzin | <1.0 |
| 6″-O-malonyldaidzin | 13.51 |
| 6″-O-acetyldaidzin | 2.08 |
| Daidzein | <1.0 |
| Genistin | <1.0 |
| 6″-O-malonylgenistin | 16.63 |
| 6″-O-acetylgenistin | 4.16 |
| Genistein | <1.0 |
| Glycitin | 4.16 |
| 6″-O-malonylglycitin | 2.08 |
| Glycitein | 1.04 |
| Nitrogen Solubility Index (NSI) (%) | 88.6 |
| Viscosity (10% Dispersion) (cP) | 204 |

The total amount of ash in the soy protein isolate is measured using ash according to the ASTM, Part 15, pp. 621-622, D 1797-62 “Ash in Casein and Isolated Soy Protein.” This method includes first taking a sample of the soy protein isolate weighing between 1.0-3.0 gram(s) and placing it into a tared crucible. The sample in the weighed crucible is then heated on a hot plate set on high until sample is charred and the smoking ceases. The crucible containing the charred sample is then placed in a pre-heated muffle furnace set at 800° C. and the sample is ashed to remove organic material by heating for 2 hours. The crucible is then removed and allowed to cool to 100-200° C. The crucible is then transferred to a dessicator and allow to cool to room temperature. Finally, it is weighed and the weight recorded. The % Ash is calculated using the following formula:

% Ash=(100)(G−T)/S

Where:
G=Gross weight of crucible, g
T=Tare weight of crucible, g
100=Conversion factor to %
S=Sample weight

### Example 3

In this Example, the process as set forth in Example 1 is repeated with the exception that instead of a 10:1 water to PROCON® 2000 weight ratio, a 20:1 water to PROCON® 2000 weight ratio is used for the initial hydration and mixing to produce the dispersion. The produced isolate is analyzed to determine various properties of the soy protein isolate. The results of the analysis are shown in Table 3. All results are on a moisture-free basis unless otherwise stated.

TABLE 3

| | Amount Determined in |
|---|---|
| Composition or Element Determined | Soy Protein Isolate |
| Protein (weight percent) | 94.86 |
| Crude Fat (weight percent) | <0.1 |
| Fat by Acid Hydrolysis (weight percent) | 2.45 |
| Ash (weight percent) | 4.03 |
| Sodium (ppm) | 13,218 |
| Potassium (ppm) | 672 |
| Calcium (ppm) | 739 |
| Phosphorus (ppm) | 7408 |
| Magnesium (ppm) | 372 |
| Isoflavones | 31.3 |
| (microgram/gram total dry matter) | |
| Daidzin | <1.0 |
| 6″-O-malonyldaidzin | 8.34 |
| 6″-O-acetyldaidzin | 2.08 |
| Daidzein | <1.0 |
| Genistin | <1.0 |
| 6″-O-malonylgenistin | 11.47 |
| 6″-O-acetylgenistin | 3.13 |
| Genistein | <1.0 |
| Glycitin | 4.17 |
| 6″-O-malonylglycitin | 1.04 |
| Glycitein | 1.04 |
| Nitrogen Solubility Index (NSI) (%) | 90.1 |
| Viscosity (10% Dispersion) (cP) | 192 |

### Example 4

In this Example, the process as set forth in Example 1 is repeated with the exception that instead of a 10:1 water to PROCON® 2000 weight ratio, a 20:1 water to PROCON® 2000 weight ratio is used for the initial hydration and mixing to produce the dispersion. Additionally, the dispersion is direct steam heated and held for 30 seconds instead of 9 seconds. The produced isolate is analyzed to determine various properties of the soy protein isolate. The results of the analysis are shown in Table 4. All results are on a moisture-free basis unless otherwise stated.

TABLE 4

| | Amount Determined in |
|---|---|
| Composition or Element Determined | Soy Protein Isolate |
| Protein (weight percent) | 92.69 |
| Crude Fat (weight percent) | <0.1 |
| Fat by Acid Hydrolysis (weight percent) | 2.35 |
| Ash (weight percent) | 3.81 |
| Sodium (ppm) | 14,809 |
| Potassium (ppm) | 829 |
| Calcium (ppm) | 952 |
| Phosphorus (ppm) | 7383 |
| Magnesium (ppm) | 488 |
| Isoflavones | 27.1 |
| (microgram/gram total dry matter) | |
| Daidzin | 3.12 |
| 6″-O-malonyldaidzin | 3.12 |
| 6″-O-acetyldaidzin | 2.08 |
| Daidzein | <1.0 |
| Genistin | 9.37 |
| 6″-O-malonylgenistin | 6.25 |
| 6″-O-acetylgenistin | 3.12 |
| Genistein | <1.0 |
| Glycitin | <1.0 |
| 6″-O-malonylglycitin | <1.0 |
| Glycitein | <1.0 |
| Nitrogen Solubility Index (NSI) (%) | 83.1 |
| Viscosity (10% Dispersion) (cP) | 324 |

### Example 5

In this Example, the process as set forth in Example 1 is repeated with the exception that the pH of the heated and flash cooled slurry is adjusted to about 9.7 with sodium hydroxide prior to the two step centrifugation process. The produced isolate is analyzed to determine various properties of the soy protein isolate. The results of the analysis are shown in Table 5. All results are on a moisture-free basis unless otherwise stated.

TABLE 5

| | Amount Determined in |
|---|---|
| Composition or Element Determined | Soy Protein Isolate |
| Protein (weight percent) | 93.45 |
| Crude Fat (weight percent) | <0.1 |
| Fat by Acid Hydrolysis (weight percent) | 2.32 |
| Ash (weight percent) | 5.51 |
| Sodium (ppm) | 21,165 |
| Potassium (ppm) | 1461 |
| Calcium (ppm) | 856 |
| Phosphorus (ppm) | 11,684 |
| Magnesium (ppm) | 516 |
| Isoflavones | 121.1 |
| (microgram/gram total dry matter) | |
| Daidzin | 14.62 |
| 6″-O-malonyldaidzin | 24.02 |
| 6″-O-acetyldaidzin | 2.09 |
| Daidzein | 4.18 |
| Genistin | 25.06 |
| 6″-O-malonylgenistin | 36.55 |
| 6″-O-acetylgenistin | 5.22 |
| Genistein | 4.18 |
| Glycitin | 2.09 |
| 6″-O-malonylglycitin | 2.09 |
| Glycitein | 1.04 |
| Nitrogen Solubility Index (NSI) (%) | 81.2 |
| Viscosity (10% Dispersion) (cP) | 86 |

### Example 6

In this Example, the process as set forth in Example 1 is repeated with the exception that instead of a 10:1 water to PROCON® 2000 weight ratio, a 15:1 water to PROCON® 2000 weight ratio is used for the initial hydration and mixing. Additionally, the dispersion is direct steam heated and held for 19.5 seconds instead of 9 seconds. The produced isolate is analyzed to determine various properties of the soy protein isolate. The results of the analysis are shown in Table 6. All results are on a moisture-free basis unless otherwise stated.

TABLE 6

| | Amount Determined in |
|---|---|
| Composition or Element Determined | Soy Protein Isolate |
| Protein (weight percent) | 93.54 |
| Crude Fat (weight percent) | <0.1 |
| Fat by Acid Hydrolysis (weight percent) | 1.95 |
| Ash (weight percent) | 4.12 |
| Sodium (ppm) | 14,220 |
| Potassium (ppm) | 1450 |
| Calcium (ppm) | 946 |
| Phosphorus (ppm) | 7167 |
| Magnesium (ppm) | 421 |
| Isoflavones | 54.4 |
| (microgram/gram total dry matter) | |
| Daidzin | 7.32 |
| 6″-O-malonyldaidzin | 9.42 |
| 6″-O-acetyldaidzin | 2.09 |
| Daidzein | <1.0 |
| Genistin | 11.51 |
| 6″-O-malonylgenistin | 14.65 |
| 6″-O-acetylgenistin | 4.19 |
| Genistein | 1.05 |
| Glycitin | 2.09 |
| 6″-O-malonylglycitin | 2.09 |
| Glycitein | <1.0 |
| Nitrogen Solubility Index (NSI) (%) | 93.6 |
| Viscosity (10% Dispersion) (cP) | 230 |

### Example 7

In this Example, an available soy protein product, FXP H0140, available from The Solae Company, St. Louis, Mo., is analyzed to compare its composition to the soy protein isolates analyzed above. The results are shown in Table 7. All results are on as-is basis, unless otherwise stated (MFB=moisture-free basis).

TABLE 7

| | Amount Determined in |
|---|---|
| Composition or Element Determined | Soy Protein Isolate |
| Moisture (weight percent) | 4.77 |
| Protein (weight percent) | 86.95 |
| Protein (MFB, weight percent) | 91.36 |
| Fat by Acid Hydrolysis (weight percent) | 2.80 |
| Ash (weight percent) | 4.16 |
| Sodium (weight percent) | 1.01 |
| Potassium (weight percent) | 1.01 |
| Calcium (weight percent) | 0.10 |
| Phosphorus (weight percent) | 0.76 |
| Isoflavones | 66 |
| (Aglucon Units, microgram/gram) | |
| Nitrogen Solubility Index (NSI) (%) | 89.4 |

### Example 8

In this Example, the soy protein isolate prepared in Example 1, the available soy protein isolate FXP H0140 (The Solae Company) and the commercially available SUPRO® 760 (The Solae Company, St. Louis, Mo.) are analyzed by Gas Chromatography/Mass Spectroscopy (GC/MS) as described above for the content (measured in parts per billion) of various volatile compounds known to cause off-flavors in soy protein isolates. Specifically, the soy protein isolates were analyzed for 3-methyl butanal, pentanal, hexanal, 1-octen-3-ol, 2-pentyl furan, (E)3-octen-2-one, and (E)2-octenal content. The results are shown in Table 8.

TABLE 8

| Compound | Example 1 isolate | FXP H0140 | SUPRO ® 760 |
|---|---|---|---|
| 3-methyl butanal | 3.8 | 38 | 20.8 |
| pentanal | 56 | 532 | 712 |
| Hexanal | 236 | 1560 | 3520 |
| 1-octen-3-ol | 9.6 | 118 | 68 |
| 2-pentyl furan | 8.2 | 46 | 37 |
| (E) 3-octen-2-one | 11 | 98 | 52 |
| (E) 2-octenal | 1.6 | 13.8 | 8.0 |

### Example 9

In this Example, a soy protein isolate is prepared using a process of the present disclosure.

PROCON® 2000 (300 pounds) (The Solae Company, St. Louis, Mo.) is mixed with water and hydrated at a water to PROCON® 2000 weight ratio of about 15:1 to produce a dispersion. The water is at a temperature of about 32° C. to facilitate hydration. The dispersion is direct steam heated to about 154° C. and held at this temperature for about 9 seconds to produce a heated slurry. The heated slurry is then flash cooled to about 54° C. and is collected for further processing. The cooled slurry is centrifuged at a flow rate of about 110 pounds per minute in a co-current flow using two separation steps, each of which utilizes a decanter centrifuge (Sharples® P-3400 by Alfa-Laval, Sweden). The centrifuge cake from the first separation is diluted using water heated to about 32° C. at a 6:1 weight ratio of water to PROCON® 2000. The second centrifuge cake is discarded. The supernatant stream from the first and second centrifuge separations are combined and clarified at a rate of about 160 pounds per minute using a disc centrifuge. The solid material is discarded and the pH of the clarified supernatant is adjusted to about 4.5 using hydrochloric acid under continuous mixing to produce a precipitate.

The precipitate is washed with a 2:1 weight ratio of water to PROCON® 2000 while separating in a disc centrifuge. The liquor is discarded and the centrifuge cake is diluted with a 5:1 weight ratio of water to PROCON® 2000 and direct steam heated to about 57° C. for a time period of about 2 to 3 seconds and then separated with a decanter centrifuge. The supernatant is discarded and the concentrated cake is diluted to about 12.0% by weight solids with water.

The pH of the 12.0% solution is adjusted to about 7.2 with sodium hydroxide. The slurry is then spray dried using an inlet temperature of about 237° C. and an outlet temperature of about 93° C.

The produced isolate is analyzed to determine various properties of the soy protein isolate. The results of the analysis are shown in Table 9. All results are on a moisture-free basis unless otherwise stated.

TABLE 9

| | Amount Determined in |
|---|---|
| Composition or Element Determined | Soy Protein Isolate |
| Protein (weight percent) | 94.0 |
| Crude Fat (weight percent) | 0.3 |
| Fat by Acid Hydrolysis (weight percent) | 2.5 |
| Ash (weight percent) | 3.7 |
| Nitrogen Solubility Index (NSI) (%) | 99 |
| Viscosity (10% Dispersion) (cP) | 15 |

### Example 10

In this Example, a soy protein isolate is prepared using a process of the present disclosure.

As in Example 9, PROCON® 2000 (300 pounds) (The Solae Company, St. Louis, Mo.) is mixed with water and hydrated at a water to PROCON® 2000 weight ratio of about 15:1 to produce a dispersion. The water is at a temperature of about 32° C. to facilitate hydration. The dispersion is direct steam heated to about 154° C. and held at this temperature for about 9 seconds to produce a heated slurry. The heated slurry is then flash cooled to about 54° C. and is collected for further processing. The cooled slurry is centrifuged at a flow rate of about 110 pounds per minute in a co-current flow using two separation steps, each of which utilizes a decanter centrifuge (Sharples® P-3400 by Alfa-Laval, Sweden). The centrifuge cake from the first separation is diluted using water heated to about 32° C. at a 6:1 weight ratio of water to PROCON® 2000. The second centrifuge cake is discarded. The supernatant stream from the first and second centrifuge separations are combined and clarified at a rate of about 160 pounds per minute using a disc centrifuge. The solid material is discarded and the pH of the clarified supernatant is adjusted to about 4.5 using hydrochloric acid under continuous mixing to produce a precipitate.

The precipitate is washed with a 2:1 weight ratio of water to PROCON® 2000 while separating in a disc centrifuge. The liquor is discarded and the centrifuge cake is diluted with a 5:1 weight ratio of water to PROCON® 2000 and direct steam heated to about 57° C. for a time period of about 2 to 3 seconds and then separated with a decanter centrifuge. The supernatant is discarded and the concentrated cake is diluted to about 12.0% by weight solids with water.

The pH of the 12.0% solution is adjusted to about 9.7 with sodium hydroxide. The slurry is then heated to a temperature of about 54° C. (129.2° F.) and treated with the enzyme, Alcalase (commercially available from Novozymes, Denmark) at about 0.15% (by weight) curd solids basis. The heated slurry is enzyme treated for about 30 minutes. The enzyme treated slurry is then adjusted to a pH of from about 7 to about 8 and heated to about 154° C. (309.2° F.) to inactivated the enzyme and then flash cooled to about 54° C. (129.2° F.). Finally, the slurry is spray dried using an inlet temperature of about 237° C. and an outlet temperature of about 93° C. (199.4° F.). The produced isolate is analyzed to determine various properties of the soy protein isolate. The results of the analysis are shown in Table 10. All results are on a moisture-free basis unless otherwise stated.

TABLE 10

| | Amount Determined in |
|---|---|
| Composition or Element Determined | Soy Protein Isolate |
| Protein (weight percent) | 93.0 |
| Crude Fat (weight percent) | 0.3 |
| Fat by Acid Hydrolysis (weight percent) | 2.3 |
| Ash (weight percent) | 4.5 |
| Nitrogen Solubility Index (NSI) (%) | 95 |
| Viscosity (10% Dispersion) (cP) | 6 |

### Example 11

In this Example, a high fat soy protein isolate is prepared and then analyzed to compare its composition to the soy protein isolates analyzed above.

To produce the high fat soy protein isolate, PROCON® 2000 (300 pounds) (The Solae Company, St. Louis, Mo.) is first mixed with water and hydrated at a water to PROCON® 2000 weight ratio of about 15:1 to produce a dispersion. The dispersion is heated to about 68° C. (154.4° F.) and held for 30 minutes. The dispersion is then cooled to about 32° C. (89.6° F.) using a plate and frame heat exchanger and held for about 15 minutes. After cooling, the dispersion is centrifuged at a flow rate of about 160 pounds per minute in a co-current flow using two separation steps, each of which utilizes a decanter centrifuge (Sharples® P-3400 by Alfa-Laval, Sweden). The centrifuge cake from the first separation is diluted using water heated to about 32° C. at a 6:1 weight ratio of water to PROCON® 2000. The second centrifuge cake is discarded. The supernatant stream from the first and second centrifuge separations are combined and clarified at a rate of about 160 pounds per minute using a disc centrifuge. The solid material is discarded and the pH of the clarified supernatant is adjusted to about 4.5 using hydrochloric acid under continuous mixing to produce a precipitate.

The precipitate is washed with a 2:1 weight ratio of water to PROCON® 2000 while separating in a disc centrifuge. The liquor is discarded and the centrifuge cake is diluted with a 5:1 weight ratio of water to PROCON® 2000 and direct steam heated to about 57° C. for a time period of about 2 to 3 seconds and then separated with a decanter centrifuge. The supernatant is discarded and the concentrated cake is diluted to about 12.0% by weight solids with water.

The pH of the 12.0% solution is adjusted to about 7.2 with sodium hydroxide. The slurry is then spray dried using an inlet temperature of about 237° C. and an outlet temperature of about 93° C.

The produced isolate is analyzed to determine various properties of the soy protein isolate. The results of the analysis are shown in Table 11. All results are on a moisture-free basis unless otherwise stated.

TABLE 11

| | Amount Determined in |
|---|---|
| Composition or Element Determined | Soy Protein Isolate |
| Protein (weight percent) | 90.2 |
| Crude Fat (weight percent) | 0.24 |
| Fat by Acid Hydrolysis (weight percent) | 5.6 |
| Ash (weight percent) | 4.3 |
| Nitrogen Solubility Index (NSI) (%) | 93 |
| Viscosity (10% Dispersion) (cP) | 27 |

### Example 12

In this Example, a commercially available soy protein isolate, SUPRO® 760, available from The Solae Company (St. Louis, Mo.), is analyzed to compare its composition to the soy protein isolates analyzed above. The results are shown in Table 12. All results are on a moisture-free basis unless otherwise stated.

TABLE 12

| | Amount Determined in |
|---|---|
| Composition or Element Determined | Soy Protein Isolate |
| Protein (weight percent) | 92.3 |
| Crude Fat (weight percent) | 0.48 |
| Fat by Acid Hydrolysis (weight percent) | 4.8 |
| Ash (weight percent) | 4.3 |
| Nitrogen Solubility Index (NSI) (%) | 95 |
| Viscosity (10% Dispersion) (cP) | 28 |
| Potassium (ppm) | 400–2000 |

### Example 13

In this Example, the soy protein isolate prepared in Example 9, the soy protein isolate prepared in Example 10, the soy protein isolate prepared in Example 11, and the commercially available SUPRO® 760 (The Solae Company, St. Louis, Mo.) are analyzed by Gas Chromatography/Mass Spectroscopy (GC/MS) as described above for the content (measured in parts per billion) of various volatile compounds known to cause off-flavors in soy protein isolates. Specifically, the soy protein isolates were analyzed for 3-methyl butanal, pentanal, hexanal, 1-octen-3-ol, 2-pentyl furan, (E)3-octen-2-one, and (E)2-octenal content. The results are shown in Table 13.

TABLE 13

| | Example 9 | Example 10 | Example 11 | |
|---|---|---|---|---|
| Compound | isolate | isolate | isolate | SUPRO ® 760 |
| 3-methyl | 6.0 | 10 | 24 | 20.8 |
| butanal | | | | |
| pentanal | 65 | 38 | 620 | 712 |
| Hexanal | 345 | 140 | 2740 | 3520 |
| 1-octen-3-ol | 4.7 | 8.0 | 64 | 68 |
| 2-pentyl furan | 5.2 | 2.0 | 24 | 37 |
| (E) 3-octen-2- | 2.5 | 2.0 | 54 | 52 |
| one | | | | |
| (E) 2-octenal | <2.0 | <2.0 | 8.0 | 8.0 |

As shown in Table 13, the Example 9 and 10 isolates have lower volatile levels as compared to the SUPRO® 760 sample. Furthermore, isolates having lower levels of fat are lower in polyunsaturated lipid content, which leads to a reduced amount of flavor active volatile compounds being formed, and thus, soy protein isolates with improved flavor. This is shown in Table 13, as the Example 9 and 10 isolates, which have a lower fat content, have reduced volatile levels as compared to the higher fat content Example 11 isolate.

In view of the above, it will be seen that the several objects of the disclosure are achieved and other advantageous results obtained.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above without departing from the scope of the disclosure, it is intended that all matter contained in the above description and shown in the accompanying drawings shall be interpreted as illustrative and not in a limiting sense.

What is claimed is:

1. A soy protein isolate comprising a total fat content as measured by acid hydrolysis of less than about 3%, a total isoflavones content of less than about 200 ppm, a total potassium content of less than about 7500 ppm, and a nitrogen solubility index of at least about 60%.

2. The soy protein isolate as set forth in claim 1 further comprising less than about 10 ppb 3-methyl butanal.

3. The soy protein isolate as set forth in claim 2 further comprising less than about 200 ppb pentanal, less than about 800 ppb hexanal, less than about 20 ppb 1-octen-3-ol, less than about 20 ppb 2-pentyl furan, less than 20 ppb (E)3-octen-2-one, and less than about 4.0 ppb (E)2-octenal.

4. The soy protein isolate as set forth in claim 2 wherein a 10% dispersion of the soy protein isolate in water by weight has a viscosity of less than about 200 centipoise.

5. The soy protein isolate as set forth in claim 1 further comprising less than about 200 ppb pentanal.

6. The soy protein isolate as set forth in claim 5 further comprising less than about 400 ppb hexanal, less than about 20 ppb 1-octen-3-ol, less than about 20 ppb 2-pentyl furan, less than about 20 ppb (E)3-octen-2-one, and less than about 4.0 ppb (E)2-octenal.

7. The soy protein isolate as set forth in claim 5 wherein a 10% dispersion of the soy protein isolate in water by weight has a viscosity of less than about 200 centipoise.

8. The soy protein isolate as set forth in claim 1 further comprising less than about 400 ppb hexanal.

9. The soy protein isolate as set forth in claim 8 further comprising less than about 20 ppb 1-octen-3-ol, less than about 20 ppb 2-pentyl furan, less than about 20 ppb (E)3-octen-2-one, and less than about 4.0 ppb (E)2-octenal.

10. The soy protein isolate as set forth in claim 1 further comprising less than about 20 ppb 1-octen-3-ol.

11. The soy protein isolate as set forth in claim 10 further comprising less than about 20 ppb 2-pentyl furan, less than about 20 ppb (E)3-octen-2-one, and less than about 4.0 ppb (E)2-octenal.

12. The soy protein isolate as set forth in claim 10 wherein a 10% dispersion of the soy protein isolate in water by weight has a viscosity of less than about 200 centipoise.

13. The soy protein isolate as set forth in claim 1 further comprising less than about 20 ppb 2-pentyl furan, less than about 20 ppb (E)3-octen-2-one, and less than about 4.0 ppb (E)2-octenal.

14. The soy protein isolate as set forth in claim 1 further comprising less than about 20 ppb (E)3-octen-2-one.

15. A food product comprising the soy protein isolate as set forth in claim 1.

16. The food product as set forth in claim 15 selected from the group consisting of dry blended beverages, ready to drink neutral beverages, ready to drink acid beverages, yogurt, food and protein bars, infant formula, emulsified meat, whole muscle meat, and meat analog.

17. A soy protein isolate comprising a total fat content as measured by acid hydrolysis of less than about 3% and a total isoflavones content of less than about 50 ppm.

18. The soy protein isolate as set forth in claim 17 further comprising less than about 10 ppb 3-methyl butanal.

19. The soy protein isolate as set forth in claim 17 further comprising less than about 200 ppb pentanal.

20. The soy protein isolate as set forth in claim 17 further comprising less than about 400 ppb hexanal.

21. The soy protein isolate as set forth in claim 17 further comprising less than about 20 ppb 1-octen-3-ol.

22. The soy protein isolate as set forth in claim 17 further comprising less than about 20 ppb 2-pentyl furan.

23. The soy protein isolate as set forth in claim 17 further comprising less than about 20 ppb (E)3-octen-2-one.

24. The soy protein isolate as set forth in claim 17 further comprising less than about 4.0 ppb (E)2-octenal.

25. A process for producing a soy protein isolate, the process comprising:
hydrating with water a soy protein concentrate prepared using aqueous ethanol extraction to produce a dispersion;
heating the dispersion to a temperature of at least about 125° C. and holding the dispersion at that temperature for a period of at least about 5 seconds to about 30 seconds to produce a slurry;
separating the slurry to produce a supernatant;
adjusting the pH of the supernatant with an acid to form a precipitate;
separating the precipitate and washing the precipitate with water;
hydrating the washed precipitate to form a hydrated precipitate slurry;
adjusting the pH of the hydrated precipitate slurry to a pH of from about 7 to about 8 to form a neutralized slurry.

26. The process as set forth in claim 25 further comprising a hydrolysis step to form a hydrolyzed soy protein isolate slurry, wherein the hydrolysis step occurs after adjusting the pH of the hydrated precipitate slurry.

27. The process as set forth in claim 26 wherein the hydrolysis step comprises introducing an enzyme into the neutralized slurry to form an enzyme-containing neutralized slurry; and
heating the enzyme-containing neutralized slurry to a temperature of at least about 125° C. and holding the enzyme-containing neutralized slurry at that temperature for a period of at least about 5 seconds to form an enzyme treated soy protein isolate slurry.

28. The process as set forth in claim 25 wherein the weight ratio of water to soy protein concentrate used in the hydrating step is from about 10:1 to about 20:1.

29. The process as set forth in claim 28 wherein the dispersion is heated to a temperature of at least about 150° C.

30. The process as set forth in claim 25 wherein the dispersion is held at a temperature of about 125° C. for a period of about 30 seconds.

31. The process as set forth in claim 25 wherein the slurry is cooled to a temperature of less than about 60° C. prior to separating the slurry to produce the supernatant.

32. The process as set forth in claim 31 wherein the pH of the cooled slurry is adjusted to from about 9 to about 10 prior to separating the slurry to produce the supernatant.

33. The process as set forth in claim 31 wherein the pH of the cooled slurry is adjusted to about 9.7 prior to separating the slurry to produce the supernatant.

34. The process as set forth in claim 25 wherein the slurry is separated to produce the supernatant using centrifugation.

35. The process as set forth in claim 34 wherein the centrifugation comprises two separation steps.

36. The process as set forth in claim 25 wherein the precipitate is hydrated with water at a water to precipitate ratio of about 5:1 to produce the hydrated precipitate.

37. The process as set forth in claim 25 wherein the hydrated precipitate slurry is heated to a temperature of at least about 50° C. for at least about 5 seconds prior to adjusting the pH of the hydrated precipitate slurry.

38. The process as set forth in claim 37 wherein the heated hydrated precipitate slurry is separated to produce a liquor and a concentrated cake.

39. The process as set forth in claim 38 wherein the concentrated cake is diluted with water to a concentration of about 12% solids.

40. The process as set forth in claim 25 wherein the pH of the hydrated precipitate slurry is adjusted to a pH of from about 7.2 to about 7.6.

41. The process as set forth in claim 25 wherein the neutralized slurry is spray dried.

42. A soy protein isolate comprising a total fat content as measured by acid hydrolysis of less than about 3%, a total isoflavones content of less than about 200 ppm, a total potassium content of less than about 7500 ppm, and a nitrogen solubility index of at least about 60%, the soy protein isolate being prepared from the process comprising:
hydrating with water a soy protein concentrate prepared using aqueous ethanol extraction to produce a dispersion;
heating the dispersion to a temperature of at least about 125° C. and holding the dispersion at that temperature for a period of at least about 5 seconds to about 30 seconds to produce a slurry;
separating the slurry to produce a supernatant;
adjusting the pH of the supernatant with an acid to form a precipitate;
separating the precipitate and washing the precipitate with water;
hydrating the washed precipitate to form a hydrated precipitate slurry;
adjusting the pH of the hydrated precipitate slurry to a pH of from about 7 to about 8 to form a neutralized slurry;
introducing an enzyme into the neutralized slurry to form an enzyme-containing neutralized slurry;
heating the enzyme-containing neutralized slurry to a temperature of at least about 125° C. and holding the enzyme-containing neutralized slurry at that temperature for a period of at least about 5 seconds to form an enzyme treated soy protein isolate slurry; and
drying the enzyme treated soy protein isolate slurry.

43. A food product comprising the enzyme treated soy protein isolate of claim 42.

44. The food product of 43 selected from the group consisting of dry blended beverages, ready to drink neutral beverages, ready to drink acid beverages, yogurt, food and protein bars, infant formula, emulsified meat, whole muscle meat, and meat analogs.

45. A soy protein isolate comprising a total fat content as measured by acid hydrolysis of less than about 3%, a total isoflavones content of less than about 200 ppm, a total potassium content of less than about 7500 ppm, and a nitrogen solubility index of at least about 60%, the soy protein isolate being prepared from the process comprising:
hydrating with water a soy protein concentrate prepared using aqueous ethanol extraction to produce a dispersion;
heating the dispersion to a temperature of at least about 125° C. and holding the dispersion at that temperature for a period of at least about 5 seconds to about 30 seconds to produce a slurry;
separating the slurry to produce a supernatant;
adjusting the pH of the supernatant with an acid to form a precipitate;
separating the precipitate and washing the precipitate with water;
hydrating the washed precipitate to form a hydrated precipitate slurry;
adjusting the pH of the hydrated precipitate slurry to a pH of from about 7 to about 8 to form a neutralized slurry; and
drying the neutralized slurry.

46. A food product comprising the soy protein isolate of claim 45.

47. The food product of 46 selected from the group consisting of dry blended beverages, ready to drink neutral beverages, ready to drink acid beverages, yogurt, food and protein bars, infant formula, emulsified meat, whole muscle meat, and meat analogs.
